(19) United States
(12) Patent Application Publication
(10) Pub. No.: US 2020/0114551 A1
(43) Pub. Date: Apr. 16, 2020

(54) Process for encapsulating a bowling pin

(71) Applicant: Da Lin, New Taipei City (TW)

(72) Inventor: Da Lin, New Taipei City (TW)

(21) Appl. No.: 16/714,850

(22) Filed: Dec. 16, 2019

(51) Int. Cl. B29C 45/00; A63D 9/00; B29C 45/72; B29L 31/52

(52) U.S. Cl. CPC B29C 45/0001; B29L 2031/52; B29C 45/72; A63D 9/00

(57) ABSTRACT

A process for encapsulating a bowling pin includes placing a pin in a mold; injecting a molten plastic material into the mold to encapsulate the pin; and cooling the mold to produce a finished bowling pin wherein. The plastic material includes 80% to 60% of nylon and 20% to 40% of ion resin. Preferably, the ion resin is zinc ion resin.

### BACKGROUND OF THE INVENTION

### 1. Field of the Invention

The invention relates to bowling pins and more particularly to a process for encapsulating a bowling pin having improved compositions.

### 2. Description of Related Art

Conventionally, the shell of a bowling pin is made of nylon. The shell is advantageous for being resistant to breakage. However, the shell is also disadvantageous for being subject to more wear.

Still conventionally, the shell of a bowling pin is made of ion resin. The shell is advantageous for being resistant to wear. However, the shell is also disadvantageous for being subject to breakage.

Thus, the need for improvement still exists.

### SUMMARY OF THE INVENTION

It is therefore one object of the invention to provide a process for encapsulating a bowling pin comprising placing a pin in a mold; injecting a molten plastic material into the mold to encapsulate the pin; and cooling the mold to produce a finished bowling pin wherein the plastic material includes 80% to 60% of nylon and 20% to 40% of ion resin.

### DETAILED DESCRIPTION OF THE INVENTION

A process for encapsulating a bowling pin in accordance with the invention comprises the steps of placing a pin in a mold, injecting a molten plastic material into the mold to encapsulate the pin, and cooling the mold to produce a finished bowling pin in which the plastic material includes 80% to 60% of nylon and 20% to 40% of zinc ion resin and a shell of the bowling pin includes 80% to 60% of nylon and 20% to 40% of zinc ion resin.

It is envisaged by the invention that the shell of the bowling pin has the advantages of being resistant to breakage, being resistant to wear and capable of generating crisp sound when a bowling ball hits the bowling pin.

While the invention has been described in terms of preferred embodiments, those skilled in the art will recognize that the invention can be practiced with modifications within the spirit and scope of the appended claims.

What is claimed is:

1. A process for encapsulating a bowling pin comprising the steps of:
placing a pin in a mold;
injecting a molten plastic material into the mold to encapsulate the pin; and
cooling the mold to produce a finished bowling pin;
wherein the plastic material includes 80% to 60% of nylon and 20% to 40% of ion resin.

2. The process of claim 1, wherein the ion resin is zinc ion resin.
